(19) United States
(12) Patent Application Publication
(10) Pub. No.: US 2026/0302486 A1
(43) Pub. Date: Oct. 1, 2026

(54) BATTERY DEVICE

(71) Applicants: Hino Motors, Ltd., Tokyo (JP); TOYOTA JIDOSHA KABUSHIKI KAISHA, Toyota-shi (JP)

(72) Inventors: Akinori OKO, Tokyo (JP); Gaku HASEGAWA, Tokyo (JP); Takumi SATO, Tokyo (JP)

(73) Assignees: Hino Motors, Ltd., Tokyo (JP); TOYOTA JIDOSHA KABUSHIKI KAISHA, Toyota-shi, (JP)

(21) Appl. No.: 19/557,753

(22) Filed: Mar. 5, 2026

(30) Foreign Application Priority Data
Mar. 28, 2025 (JP) 2025-056810

(51) Int. Cl. H01M 50/258; H01M 10/613; H01M 10/6552; H01M 50/249; H01M 50/269; H01M 50/271; H01M 50/502

(52) U.S. Cl. CPC H01M 50/258; H01M 10/613; H01M 10/6552; H01M 50/249; H01M 50/269; H01M 50/271; H01M 50/502

(57) ABSTRACT

A battery device used for driving a vehicle, the battery device comprising: a plurality of battery packs (a first battery pack and a second battery pack) each including a plurality of electrodes and a case that accommodates the plurality of electrodes; and a holding member (a first holding member and a second holding member) that holds the plurality of battery packs and integrates them with each other.

### CROSS-REFERENCE TO RELATED APPLICATIONS

This application is based upon and claims the benefit of priority from Japanese Patent Application No. 2025-056810, filed on Mar. 28, 2025, the entire contents of which are incorporated herein by reference.

### TECHNICAL FIELD

The present disclosure relates to a battery device.

### BACKGROUND

Japanese Unexamined Patent Publication No. 2015-65056 describes a battery system for an automobile. This battery system includes a plurality of battery packs and a high-voltage line that connects the plurality of battery packs so as to be electrically conductive. The plurality of battery packs are, for example, arranged spaced apart from each other in a vehicle width direction.

### SUMMARY

In an electrified vehicle, it is necessary to mount a battery pack with an electrical capacity that considers the required cruising range depending on the application. In this case, there is a concern that the cost will be high because the battery packs lack versatility and it is necessary to manufacture battery packs for each of a plurality of types of electrified vehicles. In contrast, it is also conceivable to secure the electrical capacity that considers the required cruising range by mounting a plurality of battery packs as in the above-mentioned Japanese Unexamined Patent Publication No. 2015-65056, but in this case, it is necessary to mount the plurality of battery packs at positions spaced apart from each other, and the mounting process is complicated.

Therefore, an object of the present disclosure is to provide a battery device that has improved versatility and is easy to mount.

A battery device according to the present disclosure is [1] “A battery device used for driving an electrified vehicle, the battery device comprising: a plurality of battery packs each including a plurality of electrodes and a case that accommodates the plurality of electrodes; and a holding member that holds the plurality of battery packs and integrates them with each other.”

In this battery device, the electrical capacity can be changed by changing the number of battery packs held by the holding member. Therefore, versatility is improved. In addition, the plurality of battery packs are integrated with each other. Therefore, the plurality of battery packs can be mounted at once. Therefore, mounting is facilitated.

The battery device according to the present disclosure may be [2] “The battery device according to [1], further comprising a plurality of harnesses for electrically connecting the plurality of battery packs by being connected to respective electrode terminals of the plurality of battery packs.” In this way, the plurality of battery packs may be electrically connected to each other by the plurality of harnesses.

The battery device according to the present disclosure may be [3] “The battery device according to [2], further comprising a signal line for transmitting and receiving signals to and from the plurality of battery packs, wherein the plurality of harnesses are disposed on one side of the plurality of battery packs, and wherein the signal line is disposed on a side opposite to the one side of the plurality of battery packs.” In this case, the plurality of harnesses and the signal line are located on opposite sides of each other with the battery packs interposed therebetween. Therefore, it is possible to reduce the influence of noise from the plurality of harnesses, which have a relatively high voltage, on the signal line.

The battery device according to the present disclosure may be [4] “The battery device according to [2] or [3], further comprising a cooling pipe through which a coolant for cooling the plurality of battery packs flows, wherein the plurality of harnesses are disposed on one side of the plurality of battery packs, and wherein the cooling pipe is disposed on a side opposite to the one side of the plurality of battery packs.” In this case, the plurality of harnesses and the cooling pipe are located on opposite sides of each other with the battery packs interposed therebetween. Therefore, the insulation of the high-voltage harnesses is ensured.

The battery device according to the present disclosure may be [5] “The battery device according to any one of [2] to [4], further comprising a harness bracket that holds and integrates the plurality of harnesses, wherein the harness bracket holds the plurality of harnesses such that respective terminals of the plurality of harnesses face the electrode terminals when the harness bracket is disposed on a side surface of the battery pack on which the electrode terminals are provided.” In this case, since the plurality of harnesses are integrated and held by the harness bracket, when the harness bracket is disposed on the side surface of the battery pack, the plurality of harnesses can be disposed on the side surface of the battery pack at once. Therefore, the assembly of the plurality of harnesses with the plurality of battery packs is facilitated. In addition, the harness bracket holds the plurality of harnesses such that the respective terminals of the plurality of harnesses face the electrode terminals of the battery pack when the harness bracket is disposed on the side surface of the battery pack. Therefore, by connecting the terminals of the harnesses to the electrode terminals facing the terminals of the harnesses, the terminals and the electrode terminals can be connected in an appropriate combination. That is, the occurrence of incorrect assembly can be reduced.

The battery device according to the present disclosure may be [6] “The battery device according to [5], wherein the harness bracket movably holds a relatively short harness among the plurality of harnesses.” In this case, a movable range of the relatively short harness is appropriately secured. Therefore, it is facilitated to connect the terminal of the relatively short harness to the electrode terminal of the battery pack.

The battery device according to the present disclosure may be [7] “The battery device according to any one of [2] to [6], further comprising a protective cover that covers a connection part between a terminal of a harness and an electrode terminal, when viewed from an insertion/extraction direction of the terminal of the harness and the electrode terminal.” In this case, unintended access to the connection part between the terminal of the harness and the electrode terminal of the battery pack is suppressed.

The battery device according to the present disclosure may be [8] “The battery device according to any one of [1] to [7], wherein the holding member includes a first holding member and a second holding member disposed on the first holding member, and wherein the plurality of battery packs include a first battery pack held by the first holding member, and a second battery pack disposed on the first battery pack by being held by the second holding member.” In this way, when integrating the plurality of battery packs, by stacking the plurality of battery packs one above the other, the footprint of the entire battery device in a horizontal plane can be reduced.

According to the present disclosure, it is possible to provide a battery device that has improved versatility and is easy to mount.

### BRIEF DESCRIPTION OF THE DRAWINGS

FIG. 1 is a perspective view illustrating a part of a vehicle provided with a battery device according to the present embodiment.

FIG. 2 is a perspective view illustrating the battery device.

FIG. 3 is another perspective view illustrating the battery device.

FIG. 4 is an exploded perspective view of a first holding member, a second holding member, a first bracket, and a second bracket.

FIG. 5 is a perspective view illustrating a plurality of harnesses and a harness bracket 10 holding the plurality of harnesses.

FIG. 6 is a side view of the battery device.

FIGS. 7A and 7B FIG. 7A is a perspective view illustrating a protective cover. FIG. 7B is a perspective view illustrating another protective cover.

FIG. 8 is a schematic diagram illustrating a state in which a protective cover covers a connection part.

FIG. 9 is a diagram for explaining a method of mounting the battery device on a vehicle.

### DETAILED DESCRIPTION

Hereinafter, a battery device according to an embodiment will be described with reference to the drawings. In the description of each drawing, the same or corresponding elements are denoted by the same reference numerals, and redundant description may be omitted.

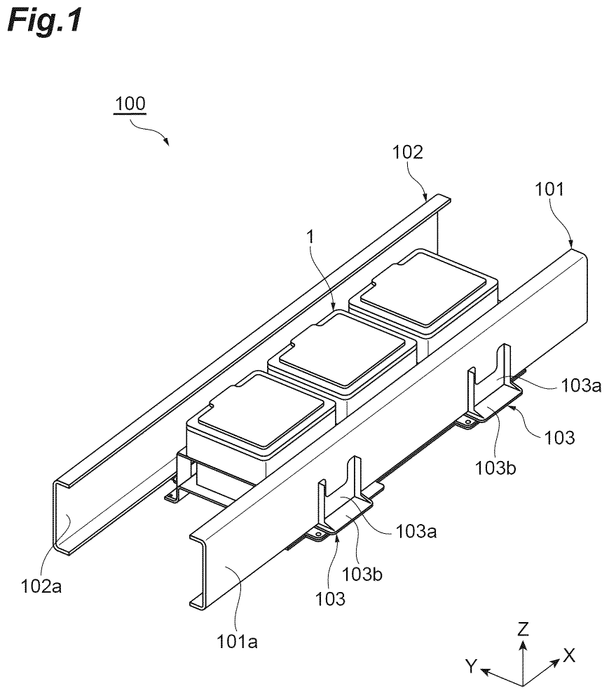

FIG. 1 is a perspective view illustrating a part of a vehicle provided with a battery device according to the present embodiment. A battery device 1 according to the present embodiment is mounted on a vehicle 100. The vehicle 100 is a large vehicle such as a truck, a freight vehicle, or a bus vehicle. The vehicle 100 is, for example, an electrified vehicle. The electrified vehicle is, for example, a hybrid electric vehicle (HEV), a plug-in hybrid electric vehicle (PHEV), a fuel cell electric vehicle (FCEV), a battery electric vehicle (BEV), or the like.

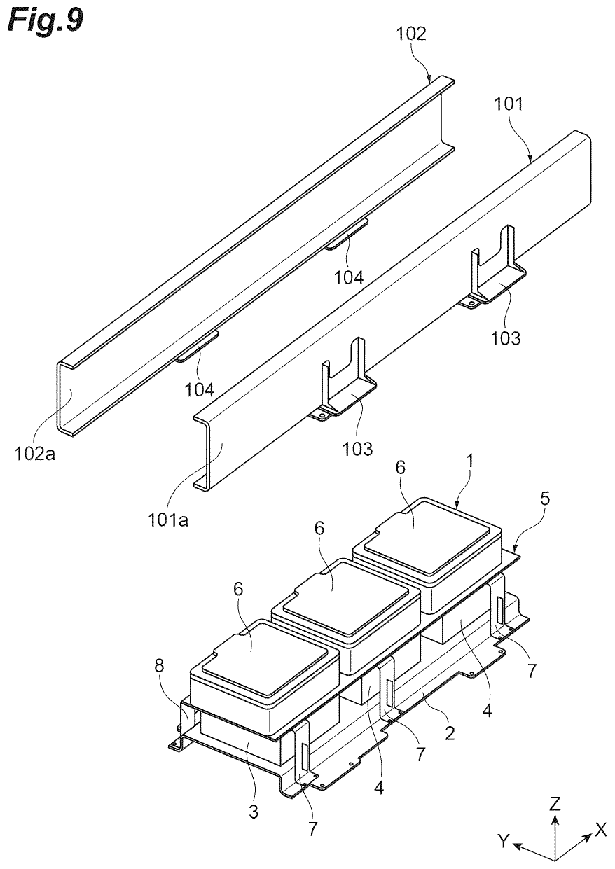

The vehicle 100 includes the battery device 1, a pair of side rails 101, 102, and a plurality of brackets 103, 104 (see FIG. 9). The side rail 101 and the side rail 102 are arranged in a vehicle width direction Y and extend in a front-rear direction X. In this specification, a forward direction and a backward direction of the vehicle 100 are referred to as a front-rear direction X of the vehicle 100, and a left-right direction when the vehicle 100 is viewed from the rear, which intersects (for example, is orthogonal to) the front-rear direction X, is referred to as a vehicle width direction Y. In addition, a direction perpendicular to the front-rear direction X and the vehicle width direction Y is referred to as an vertical direction Z.

The battery device 1 is used, for example, for driving an electrified vehicle, and has a plurality of battery packs that are integrally held. The battery device 1 is mounted between the side rail 101 and the side rail 102. The side rail 101 is formed in a U-shape having an opening on the battery device 1 side in a cross section intersecting the front-rear direction X. The side rail 102 is formed in a U-shape having an opening on the battery device 1 side in a cross section intersecting the front-rear direction X.

The brackets 103, 104 are for attaching the battery device 1 to the side rails 101, 102. In the present embodiment, a pair of brackets 103 are disposed on an outer side of the side rail 101 in the vehicle width direction Y at positions spaced apart from each other in the front-rear direction X, and a pair of brackets 104 are disposed on an outer side of the side rail 102 in the vehicle width direction Y at positions spaced apart from each other in the front-rear direction X.

The bracket 103 is formed in an L-shape when viewed from the front-rear direction X by a first portion 103a extending along the vertical direction Z and a second portion 103b extending outward in the vehicle width direction Y from a lower end of the first portion 103a. The bracket 103 is connected to a surface of a main body portion 101a of the side rail 101 facing outward in the vehicle width direction Y at the first portion 103a, and is connected to a holding member (a first holding member 2) of the battery device 1, which will be described later, at the second portion 103b, thereby fixing the battery device 1 to the side rail 101.

Similarly, the bracket 104 is formed in an L-shape when viewed from the front-rear direction X by a first portion having the same shape as the first portion 103a and a second portion having the same shape as the second portion 103b. The bracket 104 is connected to a surface of a main body portion 102a of the side rail 102 facing outward in the vehicle width direction Y at the first portion of the bracket 104, and is connected to the holding member (the first holding member 2) of the battery device 1 at the second portion of the bracket 104, thereby fixing the battery device 1 to the side rail 102.

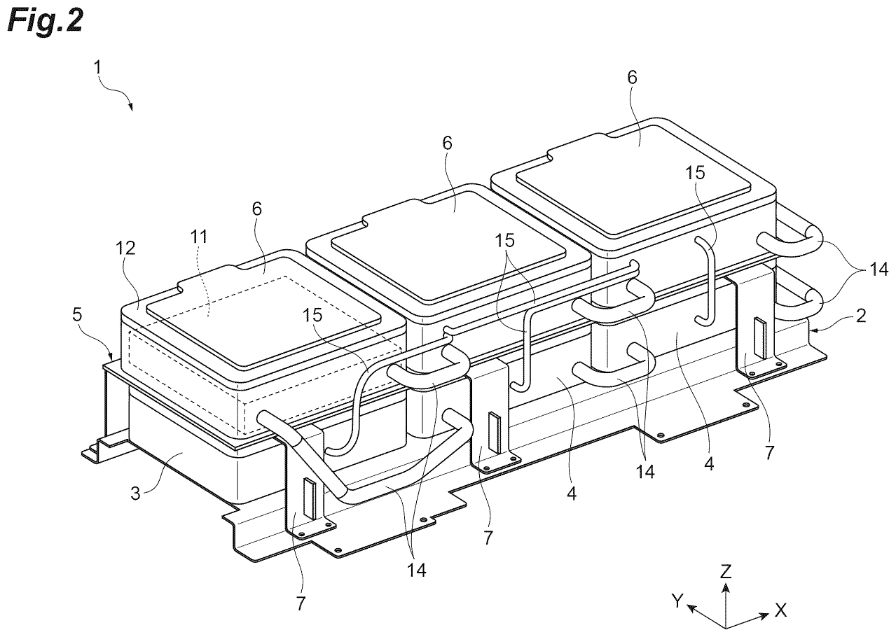

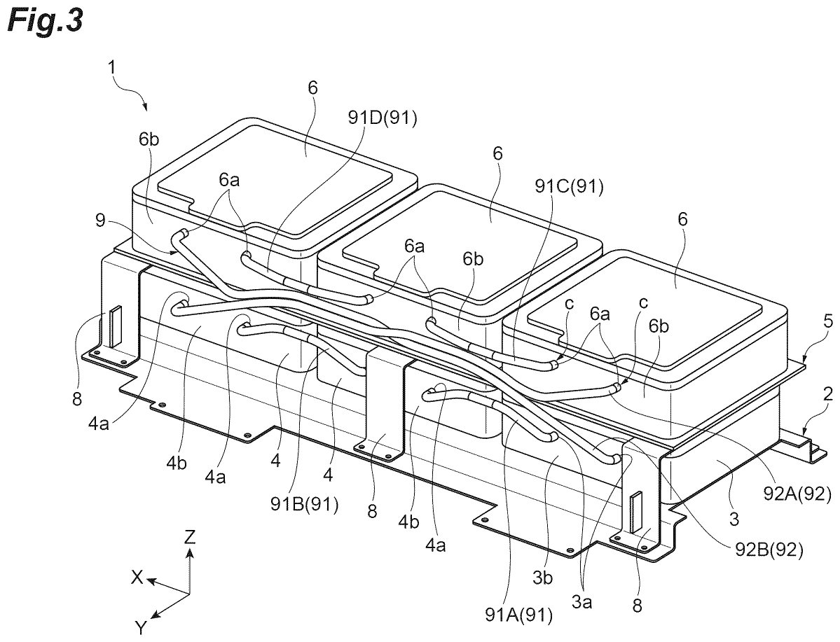

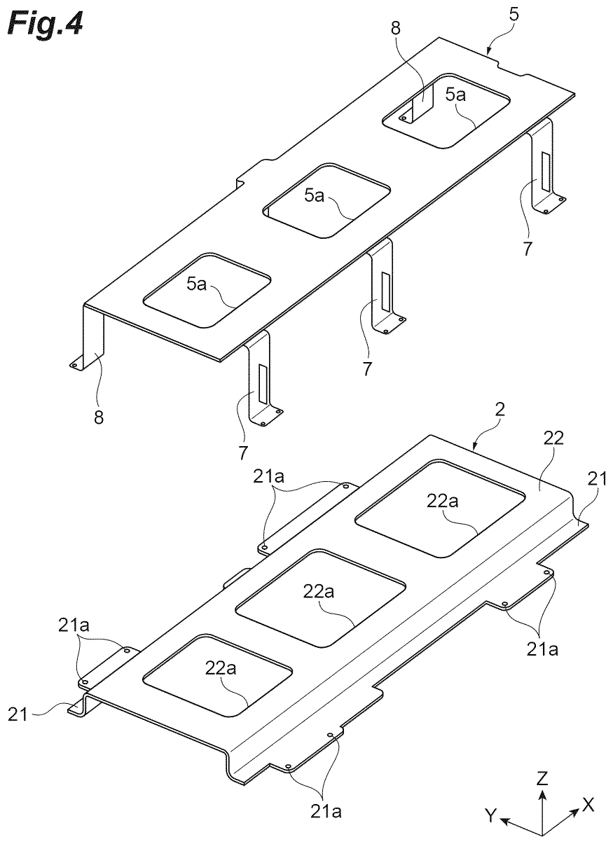

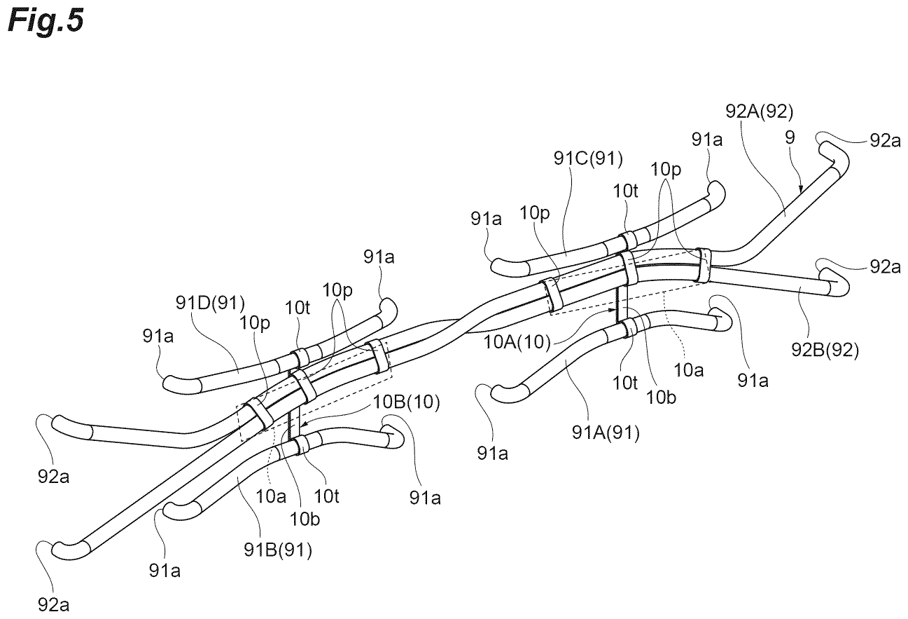

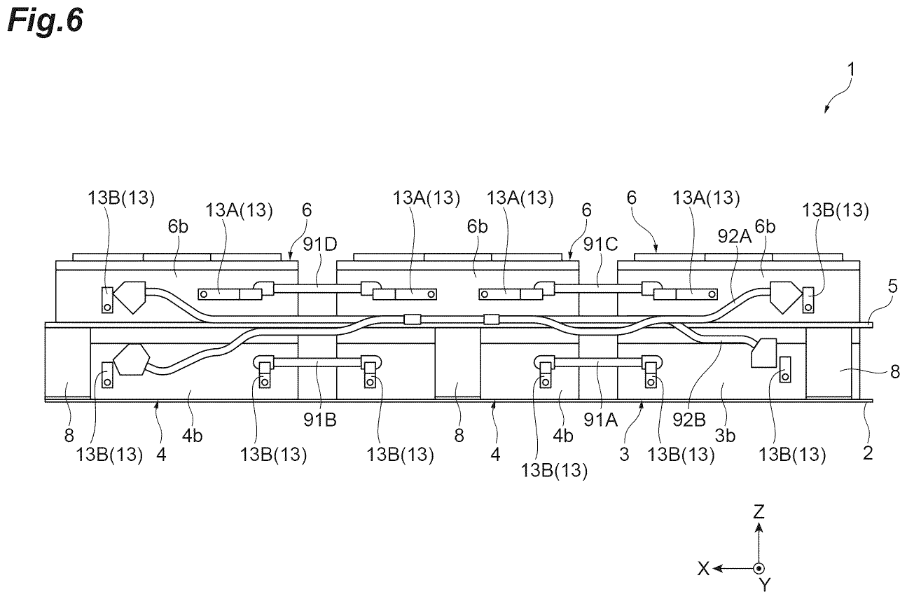

FIG. 2 is a perspective view illustrating the battery device 1. FIG. 3 is another perspective view illustrating the battery device 1. FIG. 4 is an exploded perspective view of a first holding member 2, a second holding member 5, a first bracket 7, and a second bracket 8. The battery device 1 includes a first holding member (holding member) 2, an electrical box 3, a plurality of (two in this case) first battery packs (battery packs) 4, a second holding member 5, a plurality of (three in this case) second battery packs 6, a plurality of (three in this case) first brackets 7, a plurality of (three in this case) second brackets 8, a plurality of harnesses 9, a plurality of (two in this case) harness brackets 10 (see FIG. 5), a protective cover 13 (see FIG. 6), a cooling pipe 14, and a signal line 15. Although the battery device 1 includes the harness bracket 10 and the protective cover 13, they are omitted from illustration in FIGS. 2 to 4 for the convenience of explaining other configurations.

The first battery pack 4 and the second battery pack 6 each include, for example, a plurality of electrodes 11 stacked on each other and a case 12 that accommodates the plurality of electrodes 11. As an example, each of the plurality of first battery packs 4 and each of the plurality of second battery packs 6 have the same electrical capacity, which is less than the electrical capacity required for the vehicle 100. Here, the first battery pack 4 and the second battery pack 6 are the same batteries. The plurality of first battery packs 4 and the plurality of second battery packs 6 are, for example, connected in series with each other.

In the present embodiment, the first battery pack 4 and the second battery pack 6 are formed in a similar rectangular parallelepiped shape. The first battery pack 4 has an electrode terminal 4a electrically connected to the plurality of electrodes 11 included in the first battery pack 4. The electrode terminal 4a is provided on a side surface 4b of the first battery pack 4 that faces the side rail 102. The first battery pack 4 has two electrode terminals 4a. As an example, one electrode terminal 4a is connected to a positive electrode of the plurality of electrodes 11, and the other electrode terminal 4a is connected to a negative electrode of the plurality of electrodes 11.

The second battery pack 6 has an electrode terminal 6a electrically connected to the plurality of electrodes 11 included in the second battery pack 6. The electrode terminal 6a is provided on a side surface 6b of the second battery pack 6 that faces the side rail 102. The second battery pack 6 has two electrode terminals 6a. As an example, one electrode terminal 6a is connected to a positive electrode of the plurality of electrodes 11, and the other electrode terminal 6a is connected to a negative electrode of the plurality of electrodes 11.

The electrical box 3 is electrically connected to the first battery pack 4 and the second battery pack 6. The electrical box 3 has a terminal 3a electrically connected to an electrical element included in the electrical box 3. The electrical box 3 has an outer shape similar to that of the first battery pack 4 and the second battery pack 6, and is formed in a rectangular parallelepiped shape. The terminal 3a is provided on a side surface 3b of the electrical box 3 that faces the side rail 102. The electrical box 3 has two terminals 3a. The terminal 3a and the electrode terminals 4a, 6a are disposed on the same side in the vehicle width direction Y (here, the right side of the first battery pack 4 and the second battery pack 6) with respect to the first battery pack 4 and the second battery pack 6.

The first holding member 2 holds and integrates one electrical box 3 and two first battery packs 4 arranged along the front-rear direction X. The electrical box 3 is located in front of the two first battery packs 4. The length of the first holding member 2 in the front-rear direction X is longer than the length of the first holding member 2 in the vehicle width direction Y. In a cross section intersecting the front-rear direction X, the shape of the first holding member 2 is a hat shape opening downward.

More specifically, the first holding member 2 has a pair of attachment portions 21 located at both ends in the vehicle width direction Y, and a placement portion 22 located between the pair of attachment portions 21. The attachment portions 21 and the placement portion 22 are plate-shaped. The placement portion 22 is located above the attachment portions 21, and is connected to the attachment portions 21 by portions extending perpendicularly to the placement portion 22 and the attachment portions 21. The placement portion 22 is provided with a plurality of openings 22a (three as an example) facing a lower surface of the electrical box 3 and lower surfaces of the two first battery packs 4. The opening 22a is rectangular. The attachment portions 21 are provided with a plurality of fastening holes 21a for inserting bolts for fastening the brackets 103, 104 and the first holding member 2.

The second holding member 5 holds the second battery packs 6. The second holding member 5 holds and integrates three second battery packs 6 arranged along the front-rear direction X. The second holding member 5 is disposed on the first holding member 2, and is fixed to the first holding member 2 by a first bracket 7 and a second bracket 8 as will be described later. The second holding member 5 is spaced apart from the first holding member 2, and the electrical box 3 and the first battery packs 4 are disposed between the first holding member 2 and the second holding member 5. The second holding member 5 is not in contact with the electrical box 3 and the first battery packs 4. The second battery packs 6 are disposed on the first battery packs 4 by being held by the second holding member 5 in a state of being placed on the second holding member 5.

The second holding member 5 is plate-shaped. The length of the second holding member 5 in the front-rear direction X is equal to the length of the first holding member 2 in the front-rear direction X. The length of the second holding member 5 in the vehicle width direction Y is shorter than the length of the first holding member 2 in the vehicle width direction Y. The second holding member 5 is provided with a plurality of openings 5a (three as an example) facing lower surfaces of the three second battery packs 6. The opening 5a is rectangular.

The first bracket 7 is provided upright on the first holding member 2. More specifically, the first bracket 7 is provided upright on the attachment portion 21 on one side of the first holding member 2 in the vehicle width direction Y. The first bracket 7 extends upward in a state where one end thereof is fixed to the first holding member 2, and the other end thereof is fixed to the second holding member 5. As a result, the first bracket 7 is bridged between the first holding member 2 and the second holding member 5, and fixes the first holding member 2 and the second holding member 5 to each other.

More specifically, the first bracket 7 includes a first main body portion facing the first battery pack 4, a first fixing portion extending outward along the vehicle width direction Y from a lower end portion of the first main body portion, a first placement portion extending inward along the vehicle width direction Y from an upper end portion of the first main body portion, and a first rib connected to the first main body portion and projecting outward from the first main body portion. The first fixing portion is fixed to the first holding member 2. The second holding member 5 is placed on and fixed to the first placement portion. The first rib reinforces the first bracket 7. The first bracket 7 has a Z-shape when viewed from the front-rear direction X because the first fixing portion, the first main body portion, and the first placement portion are integrally formed.

The first bracket 7 is disposed between the side rail 101 and the battery device 1 (the first battery pack 4) in the vehicle width direction Y. The first bracket 7 is made of iron. Three first brackets 7 are provided upright on the first holding member 2. More specifically, the three first brackets 7 are arranged along the front-rear direction X.

The second bracket 8 is provided upright on the first holding member 2. More specifically, the second bracket 8 is provided upright on the attachment portion 21 on the other side of the first holding member 2 in the vehicle width direction Y. The second bracket 8 extends upward in a state where one end thereof is fixed to the first holding member 2, and the other end thereof is fixed to the second holding member 5. As a result, the second bracket 8 is bridged between the first holding member 2 and the second holding member 5, and fixes the first holding member 2 and the second holding member 5 to each other.

More specifically, the second bracket 8 includes a second main body portion facing the first battery pack 4, a second fixing portion extending outward along the vehicle width direction Y from a lower end portion of the second main body portion, a second placement portion extending inward along the vehicle width direction Y from an upper end portion of the second main body portion, and a second rib connected to the second main body portion and projecting outward from the second main body portion. The second fixing portion is fixed to the first holding member 2. The second holding member 5 is placed on and fixed to the second placement portion. The second rib reinforces the second bracket 8. The second bracket 8 has a Z-shape when viewed from the front-rear direction X because the second fixing portion, the second main body portion, and the second placement portion are integrally formed.

The second bracket 8 is disposed between the side rail 102 and the battery device 1 (the first battery pack 4) in the vehicle width direction Y. The second bracket 8 is made of iron. Three second brackets 8 are provided upright on the first holding member 2. More specifically, the three second brackets 8 are arranged along the front-rear direction X.

The harness 9 and the harness bracket 10 will be described in detail with reference to FIGS. 3 and 5. FIG. 5 is a perspective view illustrating a plurality of harnesses 9 and a harness bracket 10 holding the plurality of harnesses 9. The plurality of harnesses 9 are connected to the terminal 3a of the electrical box 3, the electrode terminals 4a of the plurality of first battery packs 4, and the electrode terminals 6a of the plurality of second battery packs 6, thereby electrically connecting the electrical box 3, the plurality of first battery packs 4, and the plurality of second battery packs 6. The plurality of harnesses 9 have a plurality of (four in this case) first harnesses 91 and a plurality of (two in this case) second harnesses 92. The first harness 91 is shorter than the second harness 92. The first harness 91 is a relatively short harness among the plurality of harnesses 9.

The first harness 91 and the second harness 92 are disposed at a position facing at least one of the side surfaces 3b, 4b, 6b. The first harness 91 has terminals 91a located at each of both ends in the extending direction of the first harness 91. The second harness 92 has terminals 92a located at each of both ends in the extending direction of the second harness 92. Each of the terminals 91a, 92a is connected to any one of the terminal 3a and the electrode terminals 4a, 6a. A connection part C is formed by connecting the terminals 91a, 92a to the terminal 3a and the electrode terminals 4a, 6a.

The plurality of first harnesses 91 include first harnesses 91A, 91B, and first harnesses 91C, 91D located above the first harnesses 91A, 91B. The first harness 91A electrically connects the electrical box 3 and the first battery pack 4 adjacent to the electrical box 3. One terminal 91a of the first harness 91A is connected to the terminal 3a, and the other terminal 91a of the first harness 91A is connected to the electrode terminal 4a. The first harness 91B electrically connects the first battery pack 4 located on the front side and the first battery pack 4 located on the rear side. One terminal 91a of the first harness 91B is connected to the electrode terminal 4a of the first battery pack 4 located on the front side, and the other terminal 91a of the first harness 91B is connected to the electrode terminal 4a of the first battery pack 4 located on the rear side.

The first harness 91C electrically connects the second battery pack 6 located at the foremost position and the second battery pack 6 located in the middle. One terminal 91a of the first harness 91C is connected to the electrode terminal 6a of the second battery pack 6 located at the foremost position, and the other terminal 91a of the first harness 91C is connected to the electrode terminal 6a of the second battery pack 6 located in the middle. The first harness 91D electrically connects the second battery pack 6 located in the middle and the second battery pack 6 located at the rearmost position. One terminal 91a of the first harness 91D is connected to the electrode terminal 6a of the second battery pack 6 located in the middle, and the other terminal 91a of the first harness 91D is connected to the electrode terminal 6a of the second battery pack 6 located at the rearmost position.

The plurality of second harnesses 92 include a second harness 92A and a second harness 92B. The second harness 92A electrically connects the first battery pack 4 located on the rear side and the second battery pack 6 located at the foremost position. That is, when viewed from the vehicle width direction Y, the second harness 92A extends along a diagonal line of the battery device 1. One terminal 92a of the second harness 92A is connected to the electrode terminal 4a of the first battery pack 4, and the other terminal 92a of the second harness 92A is connected to the electrode terminal 6a of the second battery pack 6. The second harness 92B electrically connects the second battery pack 6 located at the rearmost position and the electrical box 3. That is, when viewed from the vehicle width direction Y, the second harness 92B extends along a diagonal line of the battery device 1, and the second harness 92A and the second harness 92B form an X-shape. One terminal 92a of the second harness 92B is connected to the electrode terminal 6a of the second battery pack 6, and the other terminal 92a of the second harness 92B is connected to the terminal 3a of the electrical box 3.

As described above, the first harness 91 and the second harness 92 electrically connect the electrical box 3, the first battery packs 4, and the second battery packs 6 in series.

The plurality of harness brackets 10 hold and integrate the plurality of harnesses 9. The plurality of harness brackets 10 include a harness bracket 10A and a harness bracket 10B located rearward of the harness bracket 10A. The harness bracket 10A integrally holds the first harnesses 91A, 91C and the second harnesses 92A, 92B. The harness bracket 10B integrally holds the first harnesses 91B, 91D and the second harnesses 92A, 92B. The harness brackets 10A, 10B include a first extending portion 10a extending in the front-rear direction X and a second extending portion 10b extending in the vertical direction Z. The first extending portion 10a holds the second harnesses 92A, 92B. More specifically, the first extending portion 10a bundles, locks, and holds the second harnesses 92A, 92B at a plurality of (three in this case) locations by three locking portions 10p provided at positions spaced apart in the front-rear direction X.

The second extending portion 10b is connected to the first extending portion 10a. More specifically, an intermediate portion of the second extending portion 10b in the vertical direction Z is connected to an intermediate portion of the first extending portion 10a in the front-rear direction X. That is, because the first extending portion 10a and the second extending portion 10b are integrally formed, the harness brackets 10A, 10B have a cross shape when viewed from the vehicle width direction Y.

One end of the second extending portion 10b of the harness bracket 10A holds the first harness 91A, and the other end of the second extending portion 10b of the harness bracket 10A holds the first harness 91C. More specifically, the second extending portion 10b movably locks and holds the first harnesses 91A, 91C by two locking portions 10t provided at positions spaced apart in the vertical direction Z.

One end of the second extending portion 10b of the harness bracket 10B holds the first harness 91B, and the other end of the second extending portion 10b of the harness bracket 10B holds the first harness 91D. More specifically, the second extending portion 10b movably locks and holds the first harnesses 91B, 91D by two locking portions 10t provided at positions spaced apart in the vertical direction Z.

The plurality of harnesses 9 and the plurality of harness brackets 10 are disposed on one side of each of the first battery packs 4 and the second battery packs 6. More specifically, the plurality of harnesses 9 and the plurality of harness brackets 10 are disposed between the first battery packs 4 and the second battery packs 6 and the side rail 102 in the vehicle width direction Y. The harness bracket 10 may be fastened to the first holding member 2 or the second holding member 5.

The harness bracket 10 holds the plurality of harnesses 9 such that each of the terminals 91a, 92a faces the terminals 3a and the electrode terminals 4a, 6a, respectively, when the harness bracket 10 is disposed on the side surfaces 3b, 4b, 6b. In this specification, for example, “such that the terminal 91a faces the electrode terminal 4a” includes not only that at least a part of the terminal 91a overlaps with the electrode terminal 4a when viewed from the vehicle width direction Y, but also that the electrode terminal closest to the terminal 91a is the electrode terminal 4a even if the terminal 91a does not overlap with the electrode terminal 4a when viewed from the vehicle width direction Y.

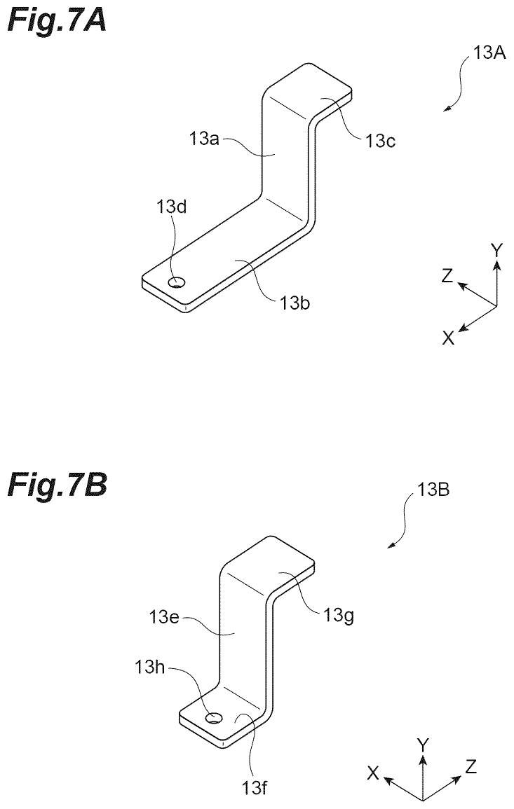

The protective cover 13 will be described in detail with reference to FIGS. 6, 7A, and 7B. FIG. 6 is a side view of the battery device 1. FIG. 7A is a perspective view illustrating a protective cover 13A. FIG. 7B is a perspective view illustrating a protective cover 13B. The protective cover 13 is a member that covers the connection part C. The protective cover 13 covers the connection part C when viewed from an insertion/extraction direction of the terminals of the plurality of harnesses 9 and the electrode terminals of the plurality of battery packs. In the present embodiment, the insertion/extraction direction is the same direction as the vehicle width direction Y.

The protective cover 13 includes a plurality of protective covers 13A extending in the front-rear direction X when viewed from the vehicle width direction Y, and a plurality of protective covers 13B extending in the vertical direction Z when viewed from the vehicle width direction Y. The protective cover 13A is attached to the second battery pack 6. The protective cover 13A has an extending portion 13a, a fixing portion 13b, and a protection portion 13c. The fixing portion 13b is a portion to be fixed to the side surface 6b. The extending portion 13a is a portion extending from the fixing portion 13b along the vehicle width direction Y. The fixing portion 13b is provided with a fastening hole 13d. The protective cover 13A is fastened to the second battery pack 6 using the fastening hole 13d. The protection portion 13c is a portion that extends from an end of the extending portion 13a opposite to the fixing portion 13b along the front-rear direction X and covers the connection part C. The protective cover 13A has a Z-shaped plate shape by the fixing portion 13b, the extending portion 13a, and the protection portion 13c being integrally formed.

The plurality of protective covers 13B include a protective cover 13B attached to the first battery pack 4, a protective cover 13B attached to the second battery pack 6, and a protective cover 13B attached to the electrical box 3. The protective cover 13B has an extending portion 13e, a fixing portion 13f, and a protection portion 13g. Hereinafter, the protective cover 13B attached to the first battery pack 4 will be described. The fixing portion 13f is a portion to be fixed to the side surface 4b. The extending portion 13e is a portion extending from the fixing portion 13f along the vehicle width direction Y. The fixing portion 13f is provided with a fastening hole 13h. The protective cover 13B is fastened to the first battery pack 4 using the fastening hole 13h. The protection portion 13g is a portion that extends from an end of the extending portion 13e opposite to the fixing portion 13f along the vertical direction Z and covers the connection part C. The protective cover 13B has a Z-shaped plate shape by the fixing portion 13f, the extending portion 13e, and the protection portion 13g being integrally formed.

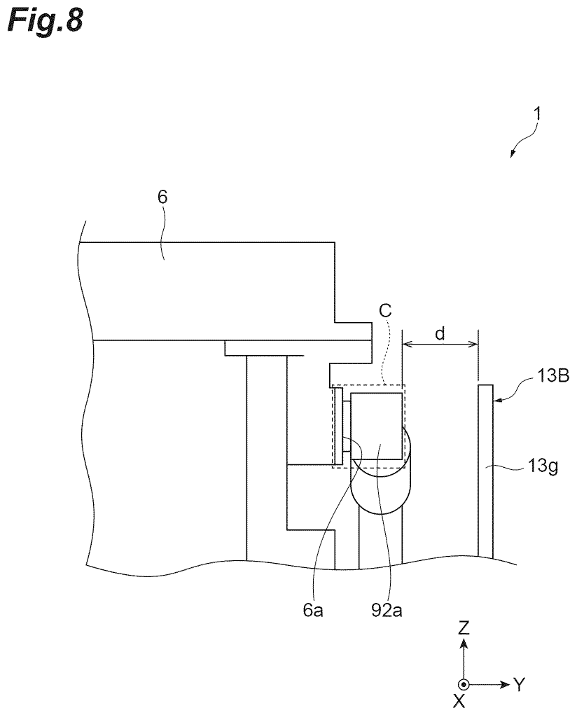

The position of the protective cover 13 with respect to the connection part C will be described with reference to FIG. 8. FIG. 8 is a schematic diagram illustrating a state in which the protective cover 13B covers the connection part C. Hereinafter, the function of the protective cover 13 will be described by taking as an example a state in which the protective cover 13B covers the connection part C between the electrode terminal 6a of the second battery pack 6 and the terminal 92a. The protective covers 13A and 13B exhibit a similar function also for a state in which the protective cover 13B covers the terminal 3a of the electrical box 3, a state in which the protective cover 13B covers the electrode terminal 4a of the first battery pack 4, and a state in which the protective cover 13A covers the electrode terminal 6a of the second battery pack 6. The protective cover 13B covers the connection part C when viewed from the vehicle width direction Y, in a state of being separated from the terminal 92a by a predetermined distanced.

The cooling pipe 14 will be described with reference to FIG. 2 again. The cooling pipe 14 is a pipe through which a coolant for cooling the plurality of first battery packs 4 and the plurality of second battery packs 6 flows. The coolant is, for example, a liquid. The cooling pipe 14 is connected to coolant flow paths inside the first battery pack 4 and inside the second battery pack 6. The cooling pipe 14 is disposed at a position facing surfaces opposite to the side surfaces 4b, 6b. That is, the cooling pipe 14 is disposed on a side opposite to the side where the harness 9 is disposed with respect to the plurality of first battery packs 4 and the plurality of second battery packs 6.

The signal line 15 is for transmitting and receiving signals to and from the plurality of first battery packs 4 and the plurality of second battery packs 6. The voltage applied to the signal line 15 is lower than the voltage applied to the harness 9. The signal line 15 is disposed at a position facing surfaces opposite to the side surfaces 3b, 4b, 6b. That is, the signal line 15 is disposed on a side opposite to the side where the harness 9 is disposed with respect to the plurality of first battery packs 4 and the plurality of second battery packs 6. The signal line 15 is disposed on the same side as the cooling pipe 14 with respect to the plurality of first battery packs 4 and the plurality of second battery packs 6.

Next, a method of mounting the battery device 1 on the vehicle 100 will be described with reference to FIG. 9. FIG. 9 is a diagram for explaining a method of mounting the battery device 1 on the vehicle 100. First, each of the brackets 103, 104 is fixed to each of the main body portion 101a of the side rail 101 and the main body portion 102a of the side rail 102. Next, the battery device 1 is placed between the side rail 101 and the side rail 102 from below the side rails 101, 102. Next, each of the brackets 103, 104 is fastened to the first holding member 2 with bolts.

The actions and effects of the battery device 1 described above will be explained. In the battery device 1, the electrical capacity can be changed by changing the number of first battery packs 4 held by the first holding member 2 and the number of second battery packs 6 held by the second holding member 5. Therefore, versatility is improved. In addition, the plurality of first battery packs 4 and the plurality of second battery packs 6 are integrated with each other. Therefore, the plurality of battery packs can be mounted at once. Therefore, mounting is facilitated.

The battery device 1 includes a plurality of harnesses 9 for electrically connecting the electrical box 3, the plurality of first battery packs 4, and the plurality of second battery packs 6 by being connected to the terminal 3a of the electrical box 3, the respective electrode terminals 4a of the plurality of first battery packs 4, and the respective electrode terminals 6a of the plurality of second battery packs 6. In this way, the electrical box 3, the plurality of first battery packs 4, and the plurality of second battery packs 6 are electrically connected to each other by the plurality of harnesses 9.

The plurality of harnesses 9 are disposed on one side of the plurality of first battery packs 4 and the plurality of second battery packs 6, and the signal line 15 is disposed on a side opposite to the one side of the plurality of first battery packs 4 and the plurality of second battery packs 6. The plurality of harnesses 9 and the signal line 15 are located on opposite sides of each other with the first battery pack 4 and the second battery pack 6 interposed therebetween. Therefore, it is possible to reduce the influence of noise from the plurality of harnesses 9, which have a relatively high voltage, on the signal line 15, which has a relatively low voltage.

The plurality of harnesses 9 are disposed on one side of the plurality of first battery packs 4 and the plurality of second battery packs 6, and the cooling pipe 14 is disposed on a side opposite to the one side of the plurality of first battery packs 4 and the plurality of second battery packs 6. The plurality of harnesses 9 and the cooling pipe 14 are located on opposite sides of each other with the first battery pack 4 and the second battery pack 6 interposed therebetween. Therefore, the insulation of the high-voltage harnesses 9 is ensured.

The harness bracket 10 holds the plurality of harnesses 9 such that the respective terminals 91a, 92a of the plurality of harnesses 9 face the terminal 3a and the electrode terminals 4a, 6a when the harness bracket 10 is disposed on the side surface 4b of the first battery pack 4 on which the electrode terminal 4a is provided, or on the side surface 6b of the second battery pack 6 on which the electrode terminal 6a is provided. Since the plurality of harnesses 9 are integrated and held by the harness bracket 10, when the harness bracket 10 is disposed on the side surface 4b of the first battery pack 4 and the side surface 6b of the second battery pack 6, the plurality of harnesses 9 can be disposed on the side surface 4b and the side surface 6b at once. Therefore, the assembly of the plurality of harnesses 9 with the plurality of first battery packs 4 and the plurality of second battery packs 6 is facilitated. In addition, the harness bracket 10 holds the plurality of harnesses 9 such that the respective terminals 91a, 92a of the plurality of harnesses 9 face the terminal 3a and the electrode terminals 4a, 6a when the harness bracket 10 is disposed on the side surface 4b and the side surface 6b. Therefore, by connecting the terminals 91a, 92a of the harness 9 to the terminal 3a and the electrode terminals 4a, 6a facing the terminals 91a, 92a, the terminals 91a, 92a and the terminal 3a and the electrode terminals 4a, 6a can be connected in appropriate combinations. That is, the occurrence of incorrect assembly can be reduced.

The harness bracket 10 holds the first harness 91, which is a relatively short harness among the plurality of harnesses 9, so as to be movable. A movable range of the relatively short first harness 91 is appropriately secured. Therefore, it is facilitated to connect the terminal 91a of the first harness 91 to the electrode terminal 4a of the first battery pack 4 and the electrode terminal 6a of the second battery pack 6.

The battery device 1 includes the protective cover 13 that covers the connection part C when viewed from an insertion/extraction direction of the terminals 91a, 92a of the harness 9 and the terminal 3a and the electrode terminals 4a, 6a. Unintended access to the connection part C is suppressed.

The holding member includes the first holding member 2 and the second holding member 5 disposed on the first holding member 2, and the plurality of battery packs include the first battery pack 4 held by the first holding member 2, and the second battery pack 6 disposed on the first battery pack 4 by being held by the second holding member 5. In this way, when integrating the plurality of battery packs, by stacking the plurality of first battery packs 4 and the plurality of second battery packs 6 one above the other, the footprint of the entire battery device 1 in a horizontal plane can be reduced.

The above embodiment has described one aspect of the battery device according to the present disclosure. Therefore, the battery device according to the present disclosure is not limited to the battery device 1 according to the above embodiment, and can be arbitrarily modified.

Although the harness 9 and the signal line 15 are located on opposite sides of each other with the first battery pack 4 and the second battery pack 6 interposed therebetween, at least one of the harness 9 and the signal line 15 may be located on the same side of the first battery pack 4 and the second battery pack 6.

Although the harness 9 and the exposed portion of the cooling pipe 14 are located on opposite sides of each other with the first battery pack 4 and the second battery pack 6 interposed therebetween, the harness 9 and the exposed portion of the cooling pipe 14 may be located on the same side of the first battery pack 4 and the second battery pack 6.

The battery device 1 may not include the harness bracket 10, and the plurality of harnesses 9 may not be integrated. The battery device 1 may not include the protective cover 13.

The harness bracket 10 may not movably hold the first harness 91. That is, the harness bracket 10 may hold the first harness 91 such that the first harness 91 is not movable.

Furthermore, the battery device 1 is not limited to a case where it includes a plurality of batteries stacked one above the other, such as the first battery pack 4 and the second battery pack 6. That is, in the battery device 1, the battery may be composed of a plurality of first battery packs 4 (or second battery packs 6), or may be a single first battery pack 4 (or second battery pack 6). In these cases, the holding member may be only the first holding member 2 (or the second holding member 5).

What is claimed is:

1. A battery device used for driving an electrified vehicle, the battery device comprising:
a plurality of battery packs each including a plurality of electrodes and a case that accommodates the plurality of electrodes; and
a holding member that holds the plurality of battery packs and integrates them with each other.

2. The battery device according to claim 1, further comprising a plurality of harnesses for electrically connecting the plurality of battery packs by being connected to respective electrode terminals of the plurality of battery packs.

3. The battery device according to claim 2, further comprising a signal line for transmitting and receiving signals to and from the plurality of battery packs,
wherein the plurality of harnesses are disposed on one side of the plurality of battery packs, and
wherein the signal line is disposed on a side opposite to the one side of the plurality of battery packs.

4. The battery device according to claim 2, further comprising a cooling pipe through which a coolant for cooling the plurality of battery packs flows,
wherein the plurality of harnesses are disposed on one side of the plurality of battery packs, and
wherein the cooling pipe is disposed on a side opposite to the one side of the plurality of battery packs.

5. The battery device according to claim 2, further comprising a harness bracket that holds and integrates the plurality of harnesses,
wherein the harness bracket holds the plurality of harnesses such that respective terminals of the plurality of harnesses face the electrode terminals when the harness bracket is disposed on a side surface of the battery pack on which the electrode terminals are provided.

6. The battery device according to claim 5 wherein the harness bracket movably holds a relatively short harness among the plurality of harnesses.

7. The battery device according to claim 2, further comprising a protective cover that covers a connection part between a terminal of a harness and an electrode terminal, when viewed from an insertion/extraction direction of the terminal of the harness and the electrode terminal.

8. The battery device according to claim 1, wherein the holding member includes a first holding member and a second holding member disposed on the first holding member, and
wherein the plurality of battery packs include a first battery pack held by the first holding member, and a second battery pack disposed on the first battery pack by being held by the second holding member.
